(19) United States
(12) Patent Application Publication
(10) Pub. No.: US 2024/0005447 A1
(43) Pub. Date: Jan. 4, 2024

(54) METHOD AND APPARATUS FOR IMAGE GENERATION FOR FACIAL DISEASE DETECTION MODEL

(71) Applicant: KONICA MINOLTA BUSINESS SOLUTIONS U.S.A., INC., Foster City, CA (US)

(72) Inventors: Hajar EMAMI, Dallas, TX (US); Junchao WEI, San Mateo, CA (US)

(21) Appl. No.: 17/855,798

(22) Filed: Jul. 1, 2022

(51) Int. Cl. G06T 3/00; G06T 7/11

(52) U.S. Cl. CPC G06T 3/0068; G06T 7/11; G06T 2207/20081; G06T 2207/30201; G06T 2207/20084

(57) ABSTRACT

Synthetic disease face image and disease facemask generation can provide training data for supervised learning of a variety of machine learning systems, including neural networks, which serve as detection models to detect disease or disorder affecting part or all of a person's face and/or cranium. Geometric transformations can be applied to facial images to generate the synthetic disease face images and disease facemasks.

### FIELD OF THE INVENTION

Aspects of the present invention relate to generation of training sets for disease detection models that use facial imagery to identify diseases and disorders. In particular, aspects of the invention relate to the use of existing facial imagery to generate additional facial imagery as part of training sets to train disease detection models.

### BACKGROUND OF THE INVENTION

Facial recognition models can be useful to identify certain types of facial diseases and disorders. Such models can supplement a doctor's examination, to help identify the correct disease or disorder before resorting to more expensive diagnostic tools such as diagnostic imaging (e.g. CT scans, MRI). These models also can provide early warning of onset of a disease or disorder.

It would be helpful to provide more robust training data to improve the performance of the facial recognition models, particularly for specific diseases or disorders.

### SUMMARY OF THE INVENTION

In view of the foregoing, according to aspects of the invention, transformations may be performed on existing facial images, whether affected or unaffected by disease or disorder, in order to generate additional training data for a facial recognition model. The transformations can be tailored to particular facial disorders, and can be applied in differing degrees to facial images to generate transformed facial images to be added to training sets for facial recognition models. In some aspects, the transformations may be applied to different portions of a facial image to focus on the kinds of facial anomalies that may be unique to a particular disease or disorder.

### BRIEF DESCRIPTION OF THE DRAWINGS

Aspects of the present invention will be described in detail with reference to the accompanying drawings, in which:

FIGS. 1A-1D are high level diagrams depicting different functions in accordance with aspects of the invention to generate artificial training sets;

FIGS. 2A-2D are high level diagrams depicting different functions in accordance with aspects of the invention to generate artificial training sets, for a specific disease or disorder;

FIGS. 3A-3D are high level diagrams depicting different functions in accordance with aspects of the invention to generate artificial training sets, for a specific disease or disorder;

FIG. 4 is a high-level flow chart illustrating performance of a method and system according to an embodiment;

FIG. 5 shows a high-level example of a system for receiving input data and generating training data according to an embodiment.

### DETAILED DESCRIPTION

Aspects of the present invention generate synthetic disease face images by adjusting a degree of disease symptoms for use in development of disease detection models. Such models can be used in primary care facilities, emergency rooms (ER), as well as in doctors' offices, prior to undertaking expensive imaging, such as CT or MRI.

Embodiments of the present invention thus can be helpful in various clinical practices, including early diagnosis and treatment planning. Acquiring a sufficient amount of training data for facial recognition models such as this can be very difficult and/or very expensive, thereby limiting the volume and quality of training data available. Existing 2D image data augmentation techniques, such as rotation, color shifting, and contrast adjustment are not effective when the images are of people. With limited training data in the form of real facial images showing a disease or disorder, a trained model may not perform as well during inference time, and may be inaccurate when it comes to diagnosing the cause of a patient's facial appearance.

Depending on the embodiment, images may be taken of someone's entire face or cranium, or of portions of the face or cranium, such as eyes, mouth, nose, ears, cheeks, or jaws.

In embodiments discussed herein, there is specific reference to two different diseases or disorders that present in the human face. Stroke is one of these. Moon face is another. Stroke is but one example of a medical condition that can cause facial drooping, in which various parts of a person's face are paralyzed and therefore seem to droop. Moon face (referred to sometimes as moon facies), in which portions of a person's face, including for example their cheeks and/or surrounding areas appear rounder or puffier, may result from different syndromes or treatments. In embodiments, training sets may be generated to enable an artificial intelligence/machine learning (AI/ML) system to detect these and other different medical conditions.

Aspects of the present invention enable the provision of supervised learning in a neural network, which may be any of a variety of neural networks, as ordinarily skilled artisans will appreciate, as well as any of a variety of machine learning systems. Recognizing that some ordinarily skilled artisans apply different definitions to different types of machine learning systems, the inventive techniques are applicable across a range of such systems, whether referred to as machine learning systems, or deep learning systems, or by another name. The inventive techniques also are applicable across a range of neural networks, for which a non-exhaustive but exemplary list includes convolutional neural networks (CNN), fully convolutional neural networks (FCNN), recurrent neural networks (RNN). The inventive techniques also can be applicable to vision transformer (ViT) networks. Sequence models to model progression of a disease or disorder can be useful for monitoring of patients over time.

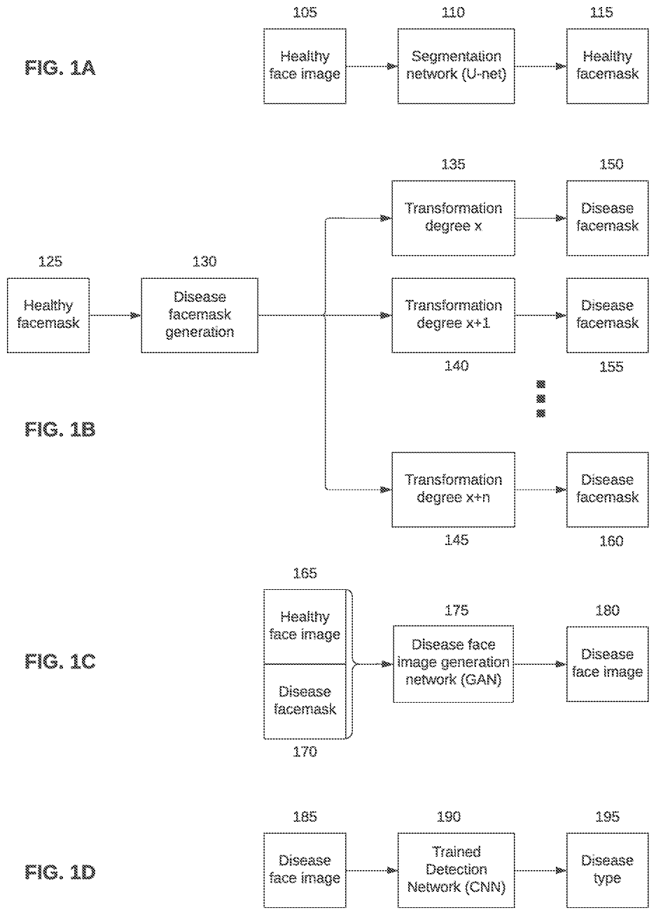

FIGS. 1A-1D describe generally how training sets may be generated, and how they may be used in detection models. In FIG. 1A, a healthy image 105 is input into an image segmentation network 110, and a facemask 115 corresponding to a healthy person is generated. The masks may have various facial attributes, such as eyes, eyelids, mouth, ears, cheeks, jaws, and other cranial parts whose distortion or disfigurement might connote a particular disease or disorder. Ordinarily skilled artisans will appreciate that other image segmentation networks may be used, and that other types of image segmentation may be suitable. According to different embodiments, for different parts of the face, clustering-based segmentation, edge segmentation, or region-based segmentation may be employed.

In an embodiment, an FCN such as U-Net may be used as an example of an image segmentation network, to generate facial images as masks. Labeling each pixel of an image enables detailed manipulation of particular facial or cranial attributes to simulate the effects of different diseases or disorders. In an embodiment, image segmentation according to aspects of the invention provides a pixel-by-pixel map of the healthy image 105 to generate the facemask 115.

In FIG. 1B, a so-called “healthy facemask” 125 is input into a disease facemask generation system 130 to generate different degrees of unhealthy (disease) facemasks. In an embodiment, a healthy facemask is subjected to various degrees of transformation 135, 140, 145. In an embodiment, the transformation may be a shear transformation, though ordinarily skilled artisans will appreciate that other geometric transformations, including affine transformations and projective transformations, as well as combinations of geometric transformations, are possible. In an embodiment, the degree of transformation 135 may be varied to show greater or lesser degrees of a particular type of facial appearance. In an embodiment employing shear transformation, for example, a transformation degree of 0.1 or 0.2 may be used to show different amounts of facial drooping. A lesser degree of transformation may not show a sufficient effect, and a greater degree of transformation may show an overly pronounced effect. As a result of the application of the transforms, a set of disease facemasks 150, 155, 160 is generated.

Depending on the embodiment, the n transforms may pertain to one particular facial feature (e.g. drooping eyelid), or may pertain to a plurality of facial features (e.g. not only drooping eyelid but also drooping mouth), or to a plurality of facial features for different diseases or disorders (e.g. drooping facial portions, other nerve-related facial anomalies, moon face, etc.) The resulting set of disease facemasks can be augmented to address additional diseases or disorders presenting as alterations of one or more facial features.

In FIG. 1C, after disease facemasks are generated in FIG. 1B, at these facemasks 165 may be input with healthy face images 170 into a disease face image generation network, such as a generative adversarial network (GAN), to generate disease face images 180. GANs are able to translate a 2D mask to generate 3D images An example of a GAN would be an algorithmic architecture using two neural networks to generate synthetic images that look real. The two neural networks may be pitted against each other to generate the synthetic images (hence the “adversarial” nature of the network). In an embodiment, there are a plurality of different healthy face images that are combined with each of the n disease facemasks to generate a training set. The training set may be considered complete at some point, or the training set can be augmented to simulate different facial diseases or disorders.

The disease face images 180 may form part of a training set that may be input to a detection network, such as a convolutional neural network (CNN), to train the detection network. Once the detection network is trained, in FIG. 1D, actual disease face images 185 may be input to the trained detection network 190, and information 195 about disease or disorder type may be output.

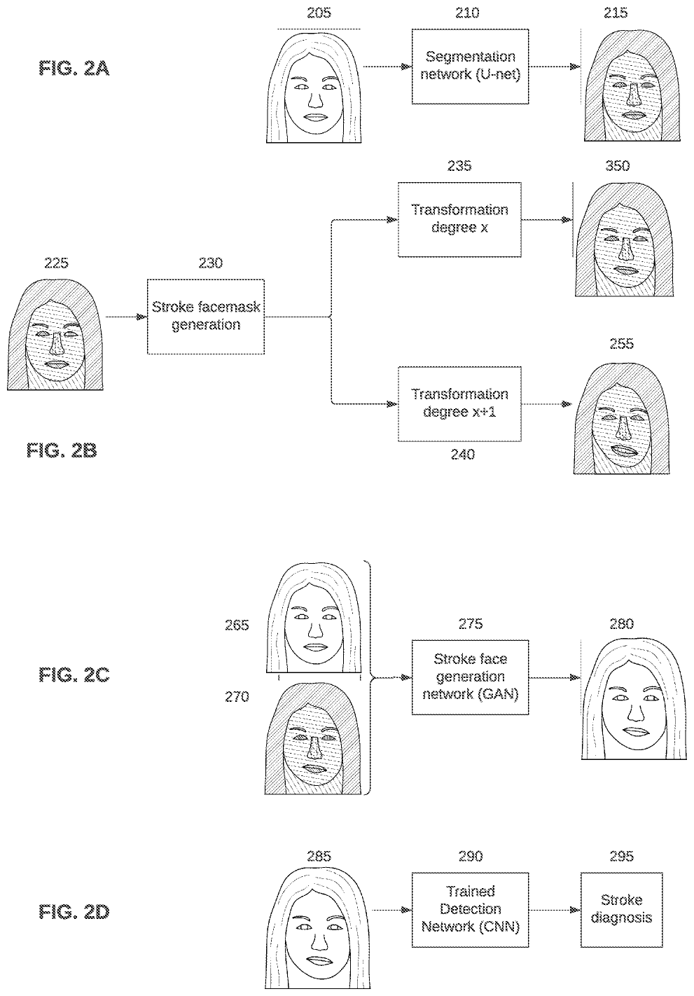

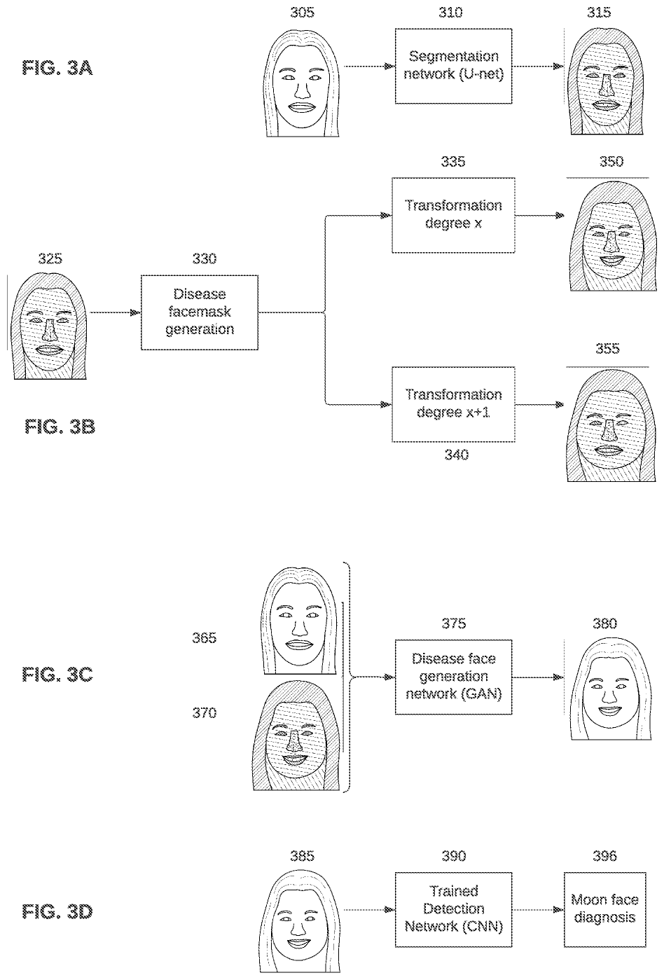

FIGS. 2A-2D correspond generally to FIGS. 1A-1D, but show specific disease facemasks, for stroke. FIGS. 3A-3D also correspond generally to FIGS. 1A-1D, but show specific disease facemasks, this time for moon face.

Different kinds of strokes can cause facial drooping to different degrees, for example ischemic stroke, hemorrhagic stroke, transient ischemic attack (mini-stroke or TIA), brain stem stroke, or even a stroke resulting from unknown causes, sometimes referred to as cryptogenic stroke.

A number of other diseases or disorders also can cause facial drooping to different degrees, including but not necessarily limited to trigeminal neuralgia, Bell's palsy, shingles (herpes zoster oticus—Ramsay Hunt syndrome), Treacher Collins syndrome (mandibulofacial dysotosis), Jacobsen syndrome, or Crouzon syndrome. Some of these just mentioned syndromes and/or disorders are more rare than others, so that doctors may need greater aid in diagnosis.

Other diseases, disorders, or in some cases medical treatments can cause moon face, for example Cushing's syndrome, or the administration of certain steroids such as prednisone.

There are other diseases or disorders which may affect different parts of the head and/or face. A non-exhaustive list of examples may include:
Craniosynostosis, which can cause the skull or facial bones to change from a normal, symmetrical appearance;
Hemifacial macrosomia, a condition mostly affecting the ear, mouth, and jaw areas, in which the tissues on one side of the face (and sometimes both sides of the face) are underdeveloped (hemifacial microsomia also may be referred to as Goldenhar syndrome, brachial arch syndrome, facio-auriculo-vertebral syndrome, oculo-auriculo-vertebral spectrum, or lateral facial dysplasia;
Vascular malformation, a birthmark or growth, present at birth, that is composed of blood vessels, and which may be referred to as lymphangioma, arteriovenous malformation, and vascular gigantism. Vascular malformation can cause functional or aesthetic problems;
Hemangioma, an abnormally growing blood vessel in the skin that may be present at birth (faint red mark) or appear in the first months after birth, and which may be referred to as a port wine stain, strawberry hemangioma, and salmon patch;
Deformational (or positional) plagiocephaly, an asymmetrical head shape of the head resulting from repeated pressure to the same area of the head;
Brain tumor;
Myasthenia gravis;
Lyme disease.

From the foregoing, ordinarily skilled artisans will appreciate that embodiments of the invention enable the generation of synthetic or artificial disease face images by adjusting a degree of disease symptoms on available normal face images. The generated disease face images may be used along with the real disease face images to train a disease recognition model.

In an embodiment, facial indications of disease or disorder may be interpreted in an end-to-end approach, using various kinds of AI/ML approaches, including deep neural networks, without a requirement that there be any measurements of a subject's face as part of any determination of the extent to which a disease or disorder is present.

An algorithm in accordance with aspects of the invention is able to modify normal face images to generate disease face images with a range of effects. Controlling a degree of disease severity in facemasks generated by the segmentation network allows this range.

According to aspects of the invention, it is possible to apply different transformations to normal facial images in order to simulate different diseases or disorders. For example, strokes involving the brain often cause central facial weakness involving the mouth and eyes. Face drooping is one of the most common signs of such a stroke. For example, one side of a stroke victim's face may become numb or weak. In an embodiment, in order to generate realistic stroke-displaying facial images, the transformation may be applied to specific facial regions that a stroke usually affects stroke (e.g., mouth, lips, and eye) without modifying other facial regions. Face segmentation masks help to apply the transformation on desired regions by excluding other regions in the transformation. Shear transformation with different degrees, for example 0.1 and 0.2, may be applied to specific regions of normal facial masks in order to generate facial distortion classes associated with a particular disease or disorder.

In an embodiment, a mask to simulate a moon face condition may be generated by adding different amounts of soft tissue to different facial regions (especially cheek and chin regions, for example), facilitating the synthesizing of realistic moon face images. Similar to the work with artificial training data sets for diagnosing strokes or other disorders or diseases, facial segmentation masks help to apply the transformation to desired regions by excluding other regions from modification.

A generated disease facial mask and a normal facial image may be used as input to the GAN model to output synthesized facial images depicting a disease or disorder. Finally, a trained CNN model may be used to detect the patient's condition and stage of severity: normal stage, watch stage (not severe, but requiring monitoring), and disease or disorder (more severe stage).

For stroke patients, it should be noted that either side of a patient's face may be affected. Accordingly, training data should include data for affectations on either the left side or the right side of a patient's face. For other disorders, the facial effects may be different, for example, affecting the eye but not the mouth, or equally affecting both sides of a patient's face.

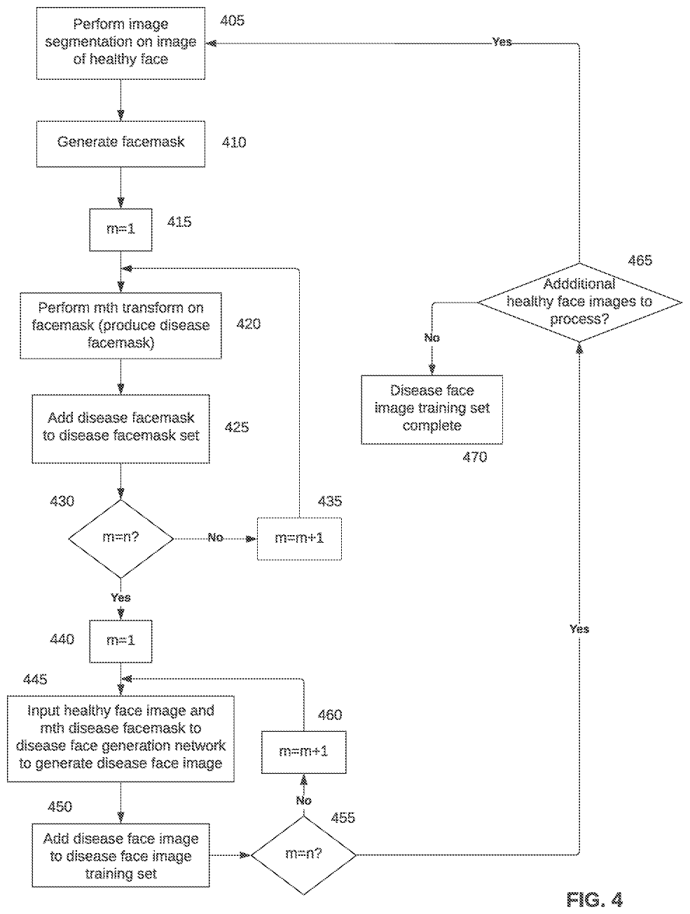

FIG. 4 is a flow chart depicting aspects of the inventive method. At 405, an image of a healthy face may be subjected to image segmentation, as described earlier. At 410, from the image segmentation, a facemask corresponding to the healthy face may be generated. Depending on the embodiment, the facemask will have various face parts that can be subjected to manipulation, whether by shear transformation or by another geometric transformation.

At 415, there is the beginning of the performance of one or more transforms (n transforms) of the facemask, by setting a counter, m, to be 1. At 420, one of the n transforms is performed to produce a disease facemask. Depending on the embodiment, the n transforms may pertain to a particular portion of a face or cranium, or to a particular degree of transformation, or both. At 425, that produced disease facemask is added to a disease facemask set. At 430, a check is made to see whether all n transforms have been performed, if not, then at 435 the counter m is incremented, and flow returns to 420. This cycle continues until all n transforms have been performed (m=n at 430 is answered in the affirmative). This just-described portion of FIG. 4 corresponds to FIG. 1B.

After the n transforms have been performed, at 440 the counter is reset, so that m=1 again. At 445, a healthy face image and one of the n disease facemasks are input to a disease face generation network to generate a disease face image. At 450, that disease face image is added to the disease face image training set. At 455, a check is made to see whether all n of the disease facemasks have been used. If not, then at 460, the counter m is incremented, and flow returns to 445. This cycle continues until all n facemasks have been used with the healthy face image (m=n at 445 is answered in the affirmative). Then, at 465, a check is made to see whether there are additional healthy face images to process. If so, flow returns to 405, and another healthy face image is input to the disease face generation network with the n disease facemasks to generate another set of disease face images. In an embodiment, once all of the healthy face images have been used, at 470 the synthetic disease face training set may be said to be complete. This just-described portion of FIG. 4 corresponds to FIG. 1C.

In an embodiment, the synthetic disease face training set may be augmented by actual disease face images.

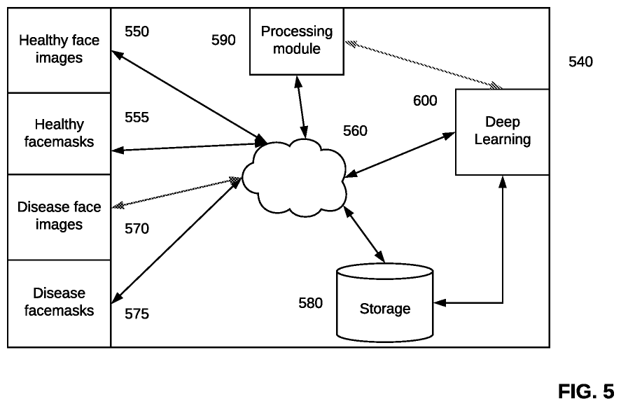

FIG. 5 is a high-level diagram of a system to train a deep learning system according to an embodiment. FIG. 5 depicts a set healthy face images 550, a set of healthy facemasks 555 which may be produced in accordance with an embodiment, a set of disease face images 570 which may comprise both synthetic disease face images generated according to an embodiment and optionally may include real disease face images, and a set of disease facemasks 575, which may comprise both synthetic disease facemasks generated according to an embodiment and optionally may include real disease facemasks. A processing system 540 may include a processing module 590, which may work with deep learning system(s) 600 to generate the healthy and disease facemasks 555, 575, and the disease face images 570. Processing module 590 may include one or more central processing units (CPUs) and/or one or more graphics processing units (GPUs) and associated non-transitory storage and/or non-transitory memory. Models and transforms of the types discussed herein normally run on GPUs Processing system 540 may be self-contained, or may have its various elements connected via a network or cloud 560. Any or all of the modules 550, 555, 570, and 575 may communicate with processing module 590 via the network or cloud 560. Storage 580 may store real disease facemasks which may be combined with the disease facemasks in module 575, and/or real disease face images which may be combined with the disease face images in module 570. Storage 580 also may store values which may be used in conjunction with the deep learning system 600. The deep learning system 600 itself may comprise any one or more of the AI/ML algorithms and apparatuses described above.

While aspects of the present invention have been described in detail with reference to various drawings, ordinarily skilled artisans will appreciate that there may be numerous variations within the scope and spirit of the invention. Accordingly, the invention is limited only by the following claims.

What is claimed is:

1. A computer-implemented method comprising:
a. performing image segmentation on a facial image to identify discrete portions of a face;
b. generating a mask comprising said discrete portions;
c. modifying one or more of said discrete portions in said mask using a transformation to modify said one or more of said discrete portions to generate a mask simulating a medical condition;
d. applying said mask to said facial image to simulate said medical condition in said facial image;
e. repeating c. and d. while varying said transformation to simulate different degrees of said medical condition;
f. repeating a. to e. for each of a plurality of facial images to produce a simulated training set to train a deep learning system.

2. The method of claim 1, wherein said medical condition is selected from the group consisting of ischemic stroke, hemorrhagic stroke, transient ischemic attack (mini-stroke or TIA), brain stem stroke, and cryptogenic stroke.

3. The method of claim 1, wherein said medical condition is selected from the group consisting of trigeminal neuralgia, Bell's palsy, Ramsay Hunt syndrome, Treacher Collins syndrome, Jacobsen syndrome, and Crouzon syndrome.

4. The method of claim 1, wherein said medical condition is moon face.

5. The method of claim 1, wherein said transformation is a geometric transformation.

6. The method of claim 1, wherein said image segmentation is performed in a machine learning system selected from the group consisting of fully convolutional neural networks and convolutional neural networks.

7. The method of claim 1, wherein said applying comprises inputting said mask and said facial image to a generative adversarial network.

8. The method of claim 1, further comprising training said deep learning system using said simulated training set.

9. The method of claim 8, further comprising training said deep learning system using said simulated training set and actual disease face images.

10. The method of claim 1, wherein said deep learning system comprises a neural network selected from the group consisting of convolutional neural networks, fully convolutional neural networks, and recurrent neural networks.

11. A system comprising:
a processor; and
a non-transitory memory storing instructions which, when performed by the processor, perform a method comprising:
a. performing image segmentation on a facial image to identify discrete portions of a face;
b. generating a mask comprising said discrete portions;
c. modifying one or more of said discrete portions in said mask using a transformation to modify said one or more of said discrete portions to simulate a medical condition;
d. applying said modifying to said facial image to simulate said medical condition in said facial image;
e. repeating c. and d. while varying said transformation to simulate different degrees of said medical condition;
f. repeating a. to e. for each of a plurality of facial images to produce a simulated training set to train a deep learning system.

12. The system of claim 11, wherein said medical condition is selected from the group consisting of ischemic stroke, hemorrhagic stroke, transient ischemic attack (mini-stroke or TIA), brain stem stroke, and cryptogenic stroke.

13. The system of claim 11, wherein said medical condition is selected from the group consisting of trigeminal neuralgia, Bell's palsy, Ramsay Hunt syndrome, Treacher Collins syndrome, Jacobsen syndrome, and Crouzon syndrome.

14. The system of claim 11, wherein said medical condition is moon face.

15. The system of claim 11, wherein said transformation is a geometric transformation.

16. The system of claim 11, wherein said image segmentation is performed in a machine learning system selected from the group consisting of fully convolutional neural networks and convolutional neural networks.

17. The system of claim 11, wherein said applying comprises inputting said mask and said facial image to a generative adversarial network.

18. The system of claim 11, further comprising training said deep learning system using said simulated training set.

19. The system of claim 18, further comprising training said deep learning system using said simulated training set and actual disease face images.

20. The system of claim 11, wherein said deep learning system comprises a neural network selected from the group consisting of convolutional neural networks, fully convolutional neural networks, and recurrent neural networks.
